(19) United States
(12) Patent Application Publication
(10) Pub. No.: US 2005/0062275 A1
(43) Pub. Date: Mar. 24, 2005

(54) Restraint system for a floor conveying vehicle

(76) Inventor: Hans Sauermann, Emsgaden (DE)

Correspondence Address: EPSTEIN DRANGEL BAZERMAN & JAMES, LLP, 60 EAST 42ND STREET, SUITE 820, NEW YORK, NY, 10165, US

(21) Appl. No.: 10/942,480

(22) Filed: Sep. 16, 2004

(30) Foreign Application Priority Data
Sep. 24, 2003 (DE) 203 14 891.6

(51) Int. Cl. B60R 22/48

(52) U.S. Cl. 280/748; 280/801.1

(57) ABSTRACT

A restraint system (1) for a vehicle, in particular a floor conveying vehicle, has a protective bar (8). The latter can be pivoted between an essentially vertically upwardly directed release position and an essentially horizontal restraint position assigned to a driver's seat. To further improve the restraint action, a seat belt (20) is fastened to the protective bar (8).

The invention relates to a restraint system for a vehicle according to the preamble of patent claim 1.

DE 202 02 522 U1 discloses a restraint system of a vehicle, which has a pivotable protective bar. In its restraint position, this protective bar secures the driver on the driver's seat when the vehicle tips over, with the result that the driver cannot slip under the tipping-over vehicle. In an upwardly pivoted release position, the driver can comfortably get into or out of the vehicle. This restraint system has been well-proven in practice and forms the starting point of the present invention.

The invention is based on the object of providing a restraint system of the type mentioned at the beginning, in which the protective bar withstands high loads and the maintenance of the vehicle is in no way obstructed.

This object is achieved according to the invention by the features of patent claim 1.

The restraint system according to the invention can be used for any desired, in particular open vehicles, but is preferably conceived for floor conveying vehicles. The vehicle has a driver's seat for the driver. During accidents, the vehicle may tip over laterally. If, in an accident of this type, the driver slips under the tipping vehicle, severe, possibly fatal injuries may occur. For this purpose, the restraint system has a protective bar which holds the driver on the driver's seat. In order to make it possible to easily get out of the vehicle in spite of the protective bar, the protective bar can be pivoted between an essentially vertically upwardly directed release position and an essentially horizontal restraint position. In the release position, the space next to the driver's seat is in no way obstructed while, in the restraint position, said space is assigned to the driver's seat and has the restraint action described. To improve the restraint action, a seat belt is fastened to the protective bar. The end of the seat belt is preferably fastened in the region of the free end of the protective bar. The effect achieved by this is that the seat belt is put on without further measures just by closing the protective bar, which means that the driver can no longer forget to put the seat belt on. When the protective bar is opened, the seat belt is automatically pulled away from the driver, so that the driver is not obstructed by the seat belt when he gets into or out of the vehicle.

In order for the protective bar to reliably withstand high lateral forces which may occur during accidents, its free end can be latched, in the restraint position, into a lock. In the restraint position, the protective bar is thereby supported at both ends in a rotary joint, on the one hand, and in the lock, on the other hand, so that there is no great leverage acting against the protective bar. The protective bar can therefore absorb considerably greater lateral forces than would be the case in protective bars held exclusively in the rotary joint. In addition, the lock prevents an inadvertent transfer of the protective bar into the release position, which would cause the protective action of the restraint system to be lost. In order not in any way to obstruct the maintenance of the vehicle, it is important for a hood which covers the engine or the battery of the vehicle to be able to be easily opened. However, the lock for locking the protective bar is held on this hood and, in particular in the case of floor conveying vehicles of small size, impacts against a rear strut when the hood is swung open. The lock would therefore prevent complete opening of the hood and would therefore considerably obstruct the maintenance of the vehicle. For this purpose, the lock is held on the hood in a manner such that it can be adjusted transversely with respect to the vehicle. If maintenance work is to be carried out, then the lock is simply adjusted outward, so that it reaches without any problem past the strut and the hood can therefore be completely opened. When the engine hood is closed, the lock is locked with regard to its pivotability in order to ensure a simple latching of the protective bar into place.

The adjustability of the lock is realized in a simple manner in the form of a pivot bearing. A pivot bearing can be realized in a simple manner and with great precision. In addition, the adjusting distance which can be achieved in this manner is generally sufficient.

As an alternative, it is favorable to displace the lock transversely with respect to the vehicle. This enables adjusting distances of any desired size to be achieved. The lock is preferably guided in a holder which has an elongated hole orientated transversely with respect to the vehicle. A pin of the lock engages in this hole, said pin being guided in the elongated hole.

In order to ensure simple operability of the protective bar, it is important for the lock to be reached in an ergonomically favorable manner from the driver's seat. As a rule, the driver's seat is designed in a manner such that it can be adjusted longitudinally with respect to the vehicle in order to permit the driver's seat to be matched to different heights of people. In order to ensure reliable operability in this case too, it is advantageous if the lock is held in a manner such that it can be displaced longitudinally with respect to the vehicle on a sliding carriage. This additionally ensures that the seat belt is matched to the particular position of the driver's seat. It is also conceivable to connect the lock to the driver's seat, so that it is optimally positioned in every position of the driver's seat without further adaptation.

In order to ensure that the protective bar corresponds at its free end to the lock, it is favorable if the protective bar can be telescoped. Preferably, the length of the protective bar is adapted in the restraint position, thus ensuring an exact alignment of the protective bar length with the lock.

In order to ensure that the lock remains in its set position and the protective bar maintains its length, it is favorable if the sliding carriage or the protective bar can be locked. Release of the locking enables the lock together with the protective bar to be easily adapted. After adaptation has taken place, the two parts are preferably locked, so that an inadvertent adjustment of the sliding carriage or of the protective bar length is no longer possible.

In order to achieve a simple opening of the protective bar, it is advantageous if at least one gas-filled spring acts on the protective bar and prestresses the latter into the release position. It is thus not necessary for the weight of the bar to be lifted in order to open it, and so the operation of the restraint system is considerably simplified.

In particular when an automatic belt is used, it is important for the protective bar to be opened sufficiently slowly in order to prevent the seat belt from becoming blocked when a protective bar is opened. On the other hand, the gas-filled spring has to be of sufficiently powerful design in order to ensure a sufficiently rapid opening of the protective bar in order for a person to leave the vehicle. This is fulfilled in the simplest manner by the thrust force of the gas-filled spring being able to be adjusted.

In order to prevent the driver from operating the vehicle without bringing the protective bar into the restraint position, it is favorable to provide at least one sensor or switch on the lock. This sensor or switch prevents operation of the vehicle when the protective bar is not latched into place, with the result that the restraint system cannot be bypassed.

In order to ensure that the seat belt always has the correct length matched to the driver, the seat belt can be rolled up in a belt roller. This also in no way restricts the freedom of movement of the driver. In order to obtain a reliable restraint action of the seat belt in an accident, the belt roller becomes blocked after a predetermined inclination. This ensures that the seat belt is locked if the vehicle tips over, even if no abrupt tensile forces are acting on the seat belt. This measure also facilitates the dimensioning of the gas-filled spring acting on the protective bar, since the seat belt can be rolled up in the belt roller irrespective of the speed of the pivoting protective bar.

In order to obtain a sufficient protective action and at the same time simple maintainability of the vehicle, it is advantageous if the belt roller has a lower response threshold in the longitudinal direction of the vehicle than in the transverse direction of the vehicle. The engine hood, which bears the driver's seat and therefore the belt roller, can therefore very easily be opened without the belt roller blocking the seat belt. However, the response threshold is higher in the transverse direction of the vehicle, so that even small inclinations of the vehicle in the transverse direction lead to the seat belt becoming blocked.

An inclination-dependent locking of the seat belt is realized in a simple manner by the use of a clamping body. In this case, the belt roller has at least one clamping body, preferably in the form of a ball, which locks the seat belt when the belt roller is pivoted. The clamping body preferably engages in corresponding wedge surfaces which trigger the locking of the seat belt. Appropriate dimensioning of the wedge surfaces enables the response threshold of the clamping body to be set within wide limits.

Finally, it is favorable to support the clamping body on a surface and to hold it in a resilient manner. This produces a simple construction of the locking mechanism for the belt roller, with the response thresholds able to be set by appropriate prestressing of the springs.

Further advantages and features of the present invention are presented in the following detailed description with reference to the associated figures, in which a plurality of exemplary embodiments of the present invention are contained. However, it should be understood that the drawing serves only for the purpose of illustrating the invention and does not restrict the range of protection of the invention.

In the drawing:

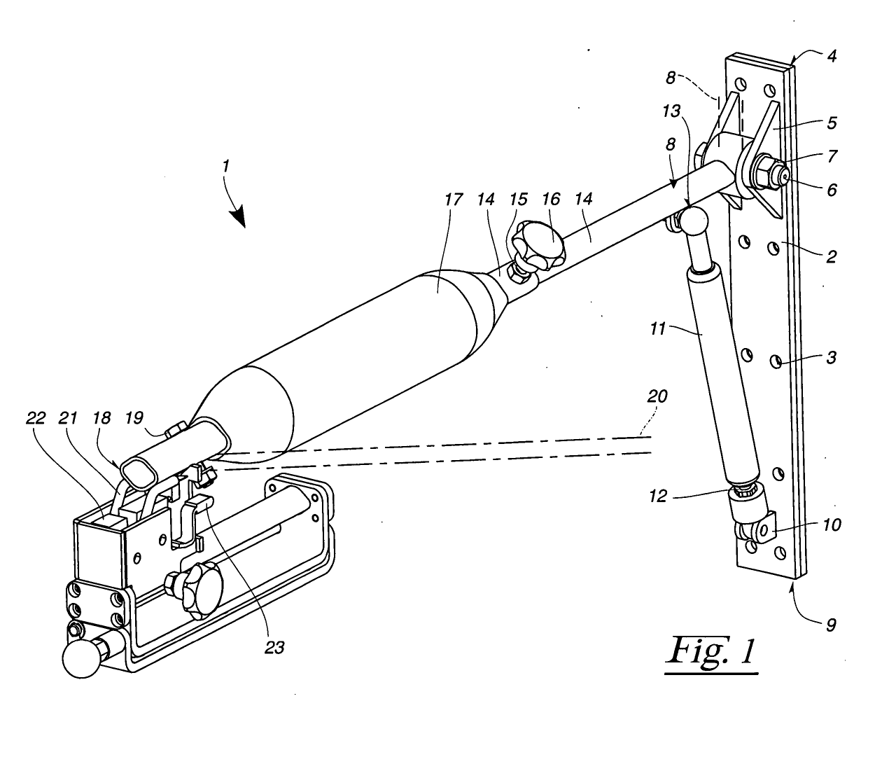

FIG. 1 shows a three-dimensional illustration of a restraint system in the restraint position,

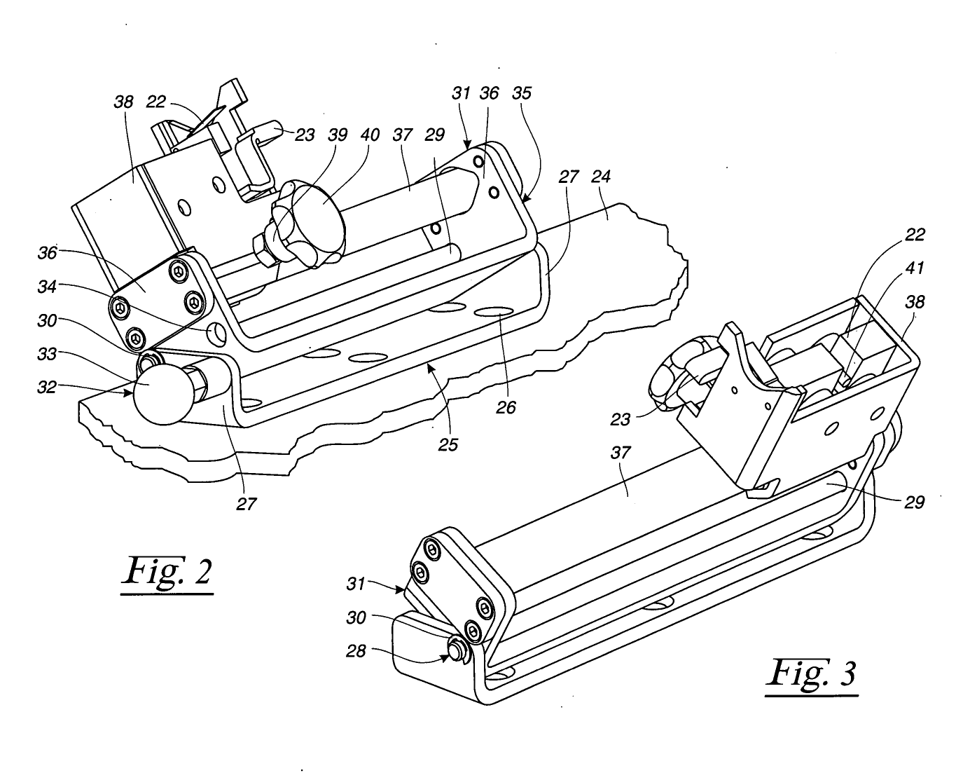

FIG. 2 shows a three-dimensional detail illustration of the restraint system according to FIG. 1,

FIG. 3 shows a further three-dimensional detail illustration according to FIG. 2, and

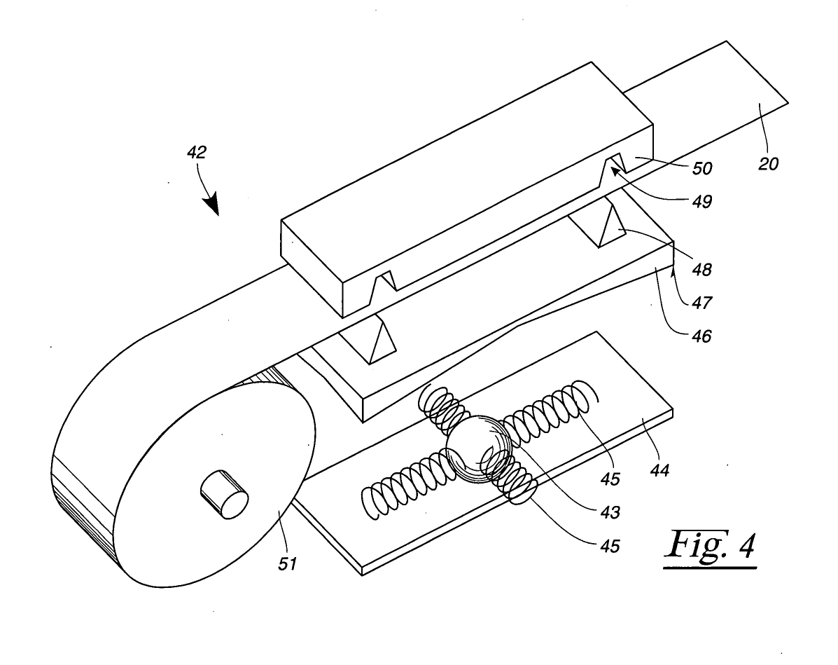

FIG. 4 shows a belt roller.

A restraint system 1 according to FIG. 1 has a flange 2 which is fastened to a front strut (not illustrated) of a floor conveying vehicle. For this purpose, a series of holes 3 through which screws (not illustrated) are passed are provided on the flange 2.

Two brackets 5 through which a common bolt 6 is passed are provided in the region of the upper end 4 of the flange 2. This bolt 6 is designed as a screw bolt with a nut 7 on the end side. The bolt 6 forms a rotary joint for a protective bar 8.

In the region of the lower end 9, further brackets 10 are provided on the flange 2 and a gas-filled spring 11 is supported pivotably on them. This gas-filled spring 11 can be changed in its strength via an adjusting screw 12. The opposite end 13 of the gas-filled spring 11 acts in an articulated manner on the protective bar 8. This enables the protective bar 8 to be prestressed by the gas-filled spring 11 from the restraint position, which is illustrated in FIG. 1, into a release position (illustrated by dashed lines).

The protective bar 8 is formed by two telescopic tubes 14 which are plugged one inside the other, so that it is of adjustable design with regard to its longitudinal extent. A locking screw 15 which can be actuated by means of a rotary knob 16 is provided in the outer telescopic tube 14. Tightening of the locking screw 15 enables the two telescopic tubes 14 to be interlocked, so that the protective bar 8 is locked with respect to a telescopic adjustment. This ensures that the protective bar 8 always has its predetermined length until the latter is consciously adjusted by opening of the locking screw 15.

In addition, a cushion 17 which is produced from a soft material is attached to the protective bar 8. This cushion 17 prevents injuries to the driver if he is pressed against the protective bar 8.

A screw bolt 19 is provided in the region of the free end 18 of the protective bar 8 and is used to fasten a seat belt 20 (indicated by chain-dotted lines) to the protective bar 8. This seat belt 20 is designed as a lap belt and, in the restraint position illustrated in FIG. 1, reaches over the entire driver's seat to the protective bar 8. The seat belt 20, in addition to the protective bar 8, therefore prevents the driver from being hurled out of the vehicle in an accident. This is important in particular in the case of vehicles having an open cab.

In the region of the free end 18 of the protective bar 8, a U-shaped latch 21 is fastened to the latter. In the restraint position which is illustrated in FIG. 1, this latch 21 engages in a lock 22. This lock 22 ensures that the protective bar 8 is locked in the restraint position. In addition, this lock 22 together with the bolt 6 brings about a mounting of the protective bar 8 on both sides, with the result that said protective bar can survive very high lateral forces without becoming deformed. All that is necessary in order to open the lock 22 is for a lever 23 to be pivoted, so that the lock mechanism releases the latch 21 and the protective bar 8 is therefore transferred by the pressure of the gas-filled spring 11 into the release position (illustrated by dashed lines). By contrast, the closing of the lock 22 takes place by simple pressing of the protective bar 8 into the lock 22.

The restraint system 1 is described further with reference to the detail illustrations according to FIGS. 2 and 3. A U-shaped holding profile 25 is firmly screwed on a hood 24, which covers the engine or battery space of the floor conveying vehicle. For the sake of simplicity, the screw bolts required for this purpose are not illustrated and instead only holes 26 in the holding profile 25 can be seen. Holes 28 which are aligned with each other are provided on the upwardly drawn limbs 27 of the holding profile 25 and are passed through by a common bolt 29. This bolt 29 is secured at both ends by split pins 30 and forms a pivot bearing for a sliding guide 31. This enables the sliding guide 31 and therefore the lock 22 to be pivoted outward when the hood 24 is to be opened. In this case, the lock 22 does not obstruct the opening of the hood 24 even if the lock 22, in the restraint position illustrated in FIG. 1, is aligned with a rear strut of the floor conveying vehicle. This considerably facilitates the maintenance work for the floor conveying vehicle.

In order to be able to lock the sliding guide 31 in the restraint position, the limb 27 of the holding profile 25 is provided with a locking device 32. This locking device 32 is formed by a handle 33 which is connected to a locking pin (not visible). This locking pin is prestressed together with the handle 33 resiliently against the sliding guide 31. The sliding guide 31 has a hole 34 which, in a swung-in position, is aligned with the locking pin. Accordingly, when the sliding guide 31 pivots into the restraint position illustrated in FIG. 1, the locking pin, because of the resilient prestress, engages in the hole 34 and locks said sliding guide with respect to further pivoting. In order to be able to again pivot the sliding carriage 31, the handle 33 together with the locking pin fastened to it has to be pulled out, so that the locking pin no longer engages in the hole 34.

The sliding guide 31 is formed by a U-shaped profile 35 through which the bolt 29 passes. A rail 37 on which a sliding carriage 38 is held in a longitudinally displaceable manner is held between the upwardly drawn limbs 36 of the profile 35.

The sliding carriage 38 is passed through by a locking screw 39 which can be operated by means of a rotary knob 40. With the aid of this locking screw 39, the sliding carriage 38 can be locked in any desired position in order to prevent a further, inadvertent displacement of the sliding carriage 38. The lock 22 which receives the latch 21 of the protective bar 8 is provided in the sliding carriage 38.

In addition, a switch 41 is provided in the lock 22 and is actuated by the latch 21 of the protective bar 8. This switch 41 detects the latching of the latch 21 to place and releases the functions of the floor conveying vehicle only if the protective bar 8 is in the restraint position.

FIG. 4 shows a three-dimensional exploded illustration of a belt roller 42. This belt roller 42 has a clamping body 43 which is supported in a two-dimensionally displaceable manner on a surface 44. The clamping body 43 is designed in the form of a ball and is centered approximately centrally with respect to the surface 44 by four springs 45. Inclination of the belt roller 42 and therefore of the surface 44 causes the clamping body 43 to exert an additional force parallel to the surface 44, so that the clamping body 43 is displaced relative to the surface 44.

A wedge 46 which, in FIG. 4, is illustrated further away from the clamping body 43 in order to see it better is held just above the clamping body 43. This wedge 46 has downwardly directed wedge surfaces whose distance from the surface 44 is at the smallest in the region of the corners 47. Displacement of the clamping body 43 causes the wedge 46 to be pushed upward in order to clamp the seat belt 20.

For this purpose, the wedge 46 has ribs 48 which correspond with corresponding openings 46 of an abutment 50. The seat belt 20 is guided between the wedge 46 and the abutment 50, so that it is locked after a certain inclination of the belt roller 42. The belt roller 42 also has a coiler 51 which coils up the seat belt 20. This coiler 51 is assigned a torsion spring (not illustrated) which ensures that a sufficiently high tensile force is applied to the seat belt 20.

Since a number of exemplary embodiments of the present invention are not shown or described, it is to be understood that a multiplicity of changes and modifications to these exemplary embodiments which have been described is possible without departing from the essential concept and the range of protection of the invention which is defined by the claims.

List of reference numbers

1 Restraint system
2 Flange
Hole
Upper end of the flange
5 Bracket
6 Bolt
7 Nut
8 Protective
9 Lower end of the flange
10 Bracket
11 Gas-filled spring
12 Adjusting screw
13 Opposite end of the gas-filled spring
14 Telescopic tube
15 Locking screw
16 Rotary knob
17 Cushion
18 Free end of the protective bar
19 Screw bolt
20 Seat belt
21 Latch
22 Lock
23 Lever
24 Hood
25 Holding profile
26 Hole
27 Limb
28 Hole
29 Bolt
30 Split pin
31 Sliding guide
32 Locking device
33 Handle
34 Hole
35 Profile
36 Limb
37 Rail
38 Sliding carriage
39 Locking screw
40 Rotary knob
41 Switch
42 Belt roller
43 Clamping body
44 Surface
45 Spring
46 Wedge
47 Corner
48 Rib
49 Recess
50 Abutment
51 Coiler

1. A restraint system for a vehicle, in particular a floor conveying vehicle, which has a driver's seat, the restraint system having a protective bar which can be pivoted between an essentially vertically upwardly directed release position and an essentially horizontal restraint position assigned to the driver's seat, wherein a seat belt is fastened to the protective bar.

2. The restraint system as claimed in claim 1, wherein the free end of the protective bar can be latched, in the restraint position, into a lock which is fitted on a pivotable hood of the vehicle, the lock being held on the hood in a manner such that it can be adjusted transversely with respect to the vehicle and locked.

3. The restraint system as claimed in claim 1, wherein the lock can be pivoted about an axis directed approximately longitudinally with respect to the vehicle.

4. The restraint system as claimed in claim 1, wherein the lock can be displaced transversely with respect to the vehicle.

5. The restraint system as claimed in claim 1, wherein the lock is held in a manner such that it can be displaced longitudinally with respect to the vehicle on a sliding carriage.

6. The restraint system as claimed in claim 5, wherein the protective bar can be telescoped to match it to the position of the lock.

7. The restraint system as claimed in claim 5, wherein the lock can be locked with regard to its displaceability and the protective bar can be locked with regard to its telescoping ability.

8. The restraint system as claimed in claim 1, wherein at least one gas-filled spring acts on the protective bar and prestresses the latter into the release position.

9. The restraint system as claimed in claim 8, wherein the gas-filled spring can be adjusted.

10. The restraint system as claimed in claim 1, wherein at least one sensor is provided in the lock and permits the vehicle to be operated only when the protective bar is latched in place.

11. The restraint system as claimed in claim 1, wherein at least one switch is provided in the lock and permits the vehicle to be operated only when the protective bar is latched in place.

12. The restraint system as claimed in claim 1, wherein the seat belt can be rolled up in a belt roller which blocks the seat belt from a predetermined inclination of the belt roller.

13. The restraint system as claimed in claim 12, wherein the belt roller has a lower response threshold in the longitudinal direction of the vehicle than in the transverse direction of the vehicle.

14. The restraint system as claimed in claim 12, wherein the belt roller has at least one clamping body which, when the belt roller pivots beyond the response threshold, locks the seat belt.

15. The restraint system as claimed in claim 14, wherein the clamping body is supported and held resiliently on a surface.
